(19) United States
(12) Patent Application Publication
(10) Pub. No.: US 2016/0037032 A1
(43) Pub. Date: Feb. 4, 2016

(54) METHOD FOR DETECTING MOUNTING POSTURE OF IN-VEHICLE CAMERA AND APPARATUS THEREFOR

(71) Applicant: DENSO CORPORATION, Kariya-city (JP)

(72) Inventor: Haruyuki Iwama, Kariya-shi (JP)

(21) Appl. No.: 14/812,706

(22) Filed: Jul. 29, 2015

(30) Foreign Application Priority Data
Jul. 30, 2014 (JP) 2014-154985

(51) Int. Cl. H04N 5/225; G06T 7/00

(52) U.S. Cl. CPC H04N 5/2253; G06T 7/0018; G06T 2207/30244; G06T 2207/30252

(57) ABSTRACT

According to a method, distortion of a picked-up image is corrected. A vertical line relative to a road surface is detected from the picked-up image. A vanishing point of a group of the detected vertical lines is calculated. A rotation angle around a Z axis of an in-vehicle camera is calculated as a roll angle of the camera. A rotation angle around an X axis of the camera is calculated as a pitch angle of the camera. A boundary line between a specific part and the road surface is detected from the picked-up image, and a reference line of the vehicle is calculated based on the detected boundary line. A rotation angle around a Y axis of the camera is calculated as a yaw angle of the camera. The roll angle, pitch angle, and the yaw angle are outputted as a mounting posture of the camera.

### CROSS-REFERENCE TO RELATED APPLICATION

This application is based on and claims the benefit of priority from earlier Japanese Patent Application No. 2014-154985 filed Jul. 30, 2014, the description of which is incorporated herein by reference.

### BACKGROUND

1. Technical Field

The present invention relates to a method for detecting a mounting posture of an in-vehicle camera, which is favorable for determining whether or not the posture of the in-vehicle camera is proper, and an apparatus therefor.

2. Related Art

JP-A-2013-129264 discloses a method of calibration performed through a simple process without using a marker located on a floor surface. Specifically, the method disclosed in the patent literature includes the following steps. (1) In an image that has an imaging range including a horizontally symmetric specific part of a vehicle (e.g., bumper), a portion of the image of the specific part (hereinafter referred to as specific image portion) is extracted first. (2) Then, while an image to be processed is rotated, the specific image portion is divided into two by a vertical line passing through a midpoint of the specific image portion, the midpoint being on a horizontal coordinate of the specific image portion, and a rotation angle is calculated as a roll angle correction value. The roll angle correction value maximizes a degree of correlation of a mirror-inverted image (whose inversion axis is the vertical line) in one division of the image portion, with the other division of the image portion, or allows the degree of correlation to be a predetermined threshold or more. (3) Further, an offset between an X-axis component at a reference position on the image to be processed and an intermediate position of the specific image portion in the X-axis direction is calculated as a yaw angle correction value. (4) Further, an offset between a Y-axis component on the reference position on the image to be processed and an intermediate position of the specific image portion in the Y-axis direction is calculated as a pitch angle correction value.

The calibration method of the above technique makes use of bilateral symmetry of an object. Accordingly, a camera is required to be set up such that a bilaterally symmetric specific part is necessarily included in an imaging range (or an object included in an imaging range is necessarily bilaterally symmetric). This raises a problem of lowering the degree of freedom in the position of setting up a camera. On the other hand, recently, there is an increasing demand for a camera that is a low-cost sensor to achieve a highly safe drive assist system, while there is a trend that such a camera is set up in various positions of a vehicle. However, in an application of the technique to such a drive assist system, the constraint in the position of setting up a camera creates a great problem. For example, a side camera is generally set up at a side mirror portion of a vehicle. However, it is difficult for a side camera to pick up an image of a bilaterally symmetric specific part, such as a bumper, of the vehicle. Accordingly, the technique cannot be adopted for a side camera.

Further, the above technique approximativly treats a change of the camera posture that is in accordance with a yaw angle and a pitch angle, and a change in the perspective of an image (perspective of the bumper portion in this case) that is in accordance with the change of the camera posture. Therefore, it is problematically difficult for the technique to achieve high accuracy calibration (calculation of an angle correction value). For example, the calibration method of the above technique is based on an idea that only a roll angle influences the bilateral symmetry of the bumper portion and, accordingly, a roll angle correction value in this method is determined from the degree of the bilateral symmetry (correlation value of a mirror-inverted image). In fact, however, a yaw angle also influences the bilateral symmetry. Therefore, it is difficult to accurately calculate a roll angle and a yaw angle by this method.

### SUMMARY

An embodiment provides a technique for increasing a degree of freedom and mitigating constraint concerning the position of setting up an in-vehicle camera and enabling high accuracy calibration.

As an aspect of the embodiment, a method for detecting a mounting posture of an in-vehicle camera is provided, in which the in-vehicle camera is mounted to the vehicle such that a specific part of the vehicle is included in an imaging range, and a picked-up image is received from the in-vehicle camera so as to determine whether or not a mounting posture of the in-vehicle camera is proper. The method includes: an image input step of receiving the picked-up image; a distortion correction step correcting distortion of the received picked-up image; a vertical line detection step of detecting a vertical line relative to a road surface, from the picked-up image that has been subjected to distortion correction; a vanishing point calculation step of calculating a vanishing point of a group of the detected vertical lines; a roll angle calculation step of calculating, as a roll angle of the in-vehicle camera, a rotation angle around a Z axis of the in-vehicle camera, in a case where the calculated vanishing point of the group of vertical lines overlaps a center line of the image relative to an X direction; a pitch angle calculation step of calculating, as a pitch angle of the in-vehicle camera, a rotation angle around an X axis of the in-vehicle camera, in a case where the calculated vanishing point of the group of vertical lines corresponds to infinity; a reference line calculation step of detecting a boundary line between the specific part and the road surface from the picked-up image that has been subjected to the distortion correction, and calculating a reference line of the vehicle on the basis of the detected boundary line; and a yaw angle calculation step of calculating, as a yaw angle of the in-vehicle camera, a rotation angle around a Y axis of the in-vehicle camera, in a case where the calculated reference line of the vehicle is parallel to an image X axis. The roll angle of the in-vehicle camera, the pitch angle of the in-vehicle camera, and the yaw angle of the in-vehicle camera are outputted as a mounting posture of the in-vehicle camera.

### BRIEF DESCRIPTION OF THE DRAWINGS

In the accompanying drawings:

FIG. 1 is a block diagram illustrating a configuration of an image processing system according to an embodiment;

FIG. 2 is a diagram illustrating a mounting posture of an in-vehicle camera with respect to a vehicle, according to the embodiment;

FIG. 3 is a block diagram illustrating a configuration of an image processor, according to the embodiment;

FIG. 4 is a flow diagram illustrating an in-vehicle camera mounting posture detection process, as a main routine, performed by the image processor;

FIG. 5 is a flow diagram illustrating a sub-routine of step S3 of the main routine;

FIG. 6 is a flow diagram illustrating a sub-routine of step S4 of the main routine;

FIG. 7 is a diagram illustrating the in-vehicle camera mounting posture detection process; and

FIG. 8 is another diagram illustrating the in-vehicle camera mounting posture detection process.

### DETAILED DESCRIPTION OF THE PREFERRED EMBODIMENTS

### 1. Configuration of an Image Processing System 1

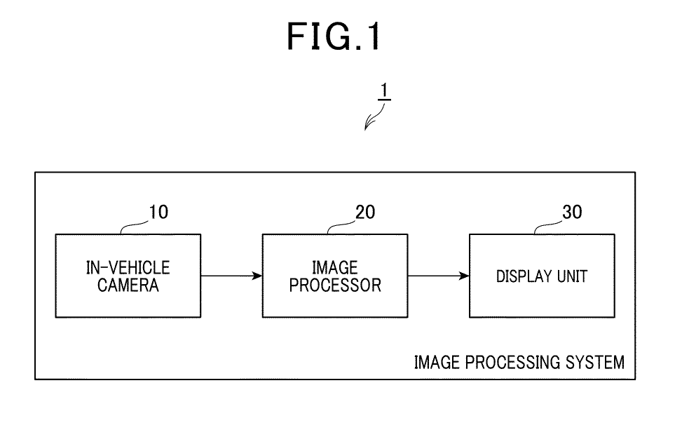

FIG. 1 is a block diagram illustrating a configuration of an image processing system 1. As shown in FIG. 1, the image processing system 1 of the present embodiment includes an in-vehicle camera 10, an image processor 20 and a display unit 30. These components will be described below one by one.

[1.1. Configuration of the in-Vehicle Camera 10]

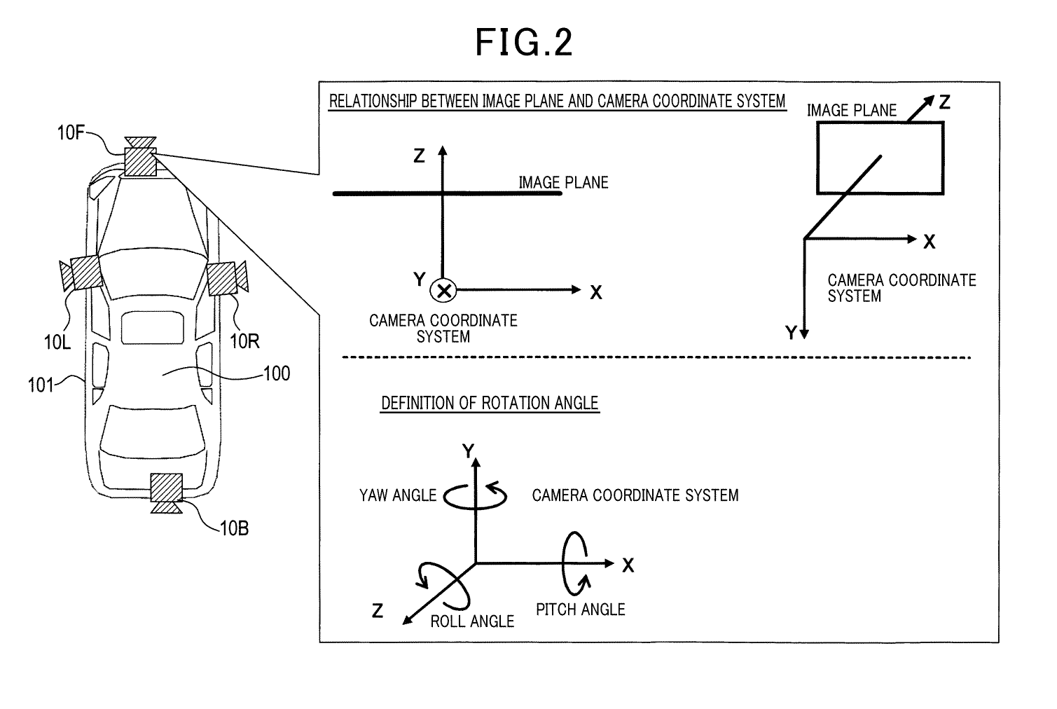

The in-vehicle camera 10 includes an image pickup device, such as a CCD (charge-coupled device) or a CMOS (complementary metal oxide semiconductor). FIG. 2 is a diagram illustrating a mounting posture of the in-vehicle camera 10 with respect to a vehicle 100. As shown in FIG. 2, the in-vehicle camera 10 includes a camera 10F set up in a front portion of the vehicle 100, a camera 10L set up in a left-side portion of the vehicle 100, a camera 10R set up in a right-side portion of the vehicle 100, and a camera 10B set up in a rear portion of the vehicle 100.

As shown in FIG. 2, the camera 10F is set up in a front portion of the vehicle 100 to pickup an image ahead of the vehicle 100. The camera 10F outputs a picked-up image ahead of the vehicle to the image processor 20 at a predetermined frequency (e.g., 60 frames per second).

As shown in FIG. 2, the camera 10L is set up in a left-side portion of the vehicle 100 to pick up an image of a left hand area of the vehicle 100. The camera 10L outputs a picked-up image to the image processor 20 at a predetermined frequency.

As shown in FIG. 2, the camera 10R is set up in a right-side portion of the vehicle 100 to pick up an image on a right hand area of the vehicle 100. The camera 10R outputs a picked-up image to the image processor 20 at a predetermined frequency.

As shown in FIG. 2, the camera 10B is set up in a rear portion of the vehicle 100 to pick up an image behind the vehicle 100. The camera 10B outputs a picked-up image to the image processor 20 at a predetermined frequency.

In a camera coordinate system of the in-vehicle camera 10, an imaging direction of the in-vehicle camera 10 is a Z-axis direction, a rightward direction relative to the imaging direction of the in-vehicle camera 10 is an X-axis direction, and a downward direction relative to the imaging direction of the in-vehicle camera 10 is a Y-axis direction. In the camera coordinate system of the in-vehicle camera 10, an inclination around the X axis is a pitch angle, an inclination around the Y axis is a yaw angle, and an inclination around the Z axis a roll angle. A picked-up image (image plane) derived from the in-vehicle camera 10 is set relative to the camera coordinate system of the in-vehicle camera 10 so as to be perpendicular to the Z-axis direction and parallel to the X- and Y-axis directions.

[1.2. Configuration of the Image Processor 20]

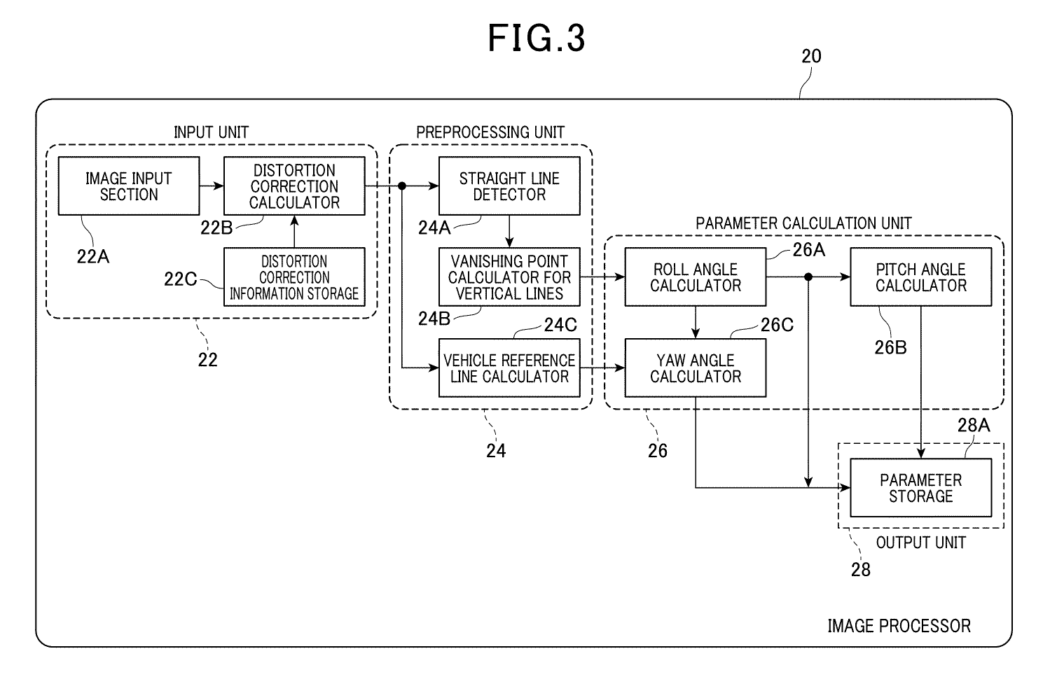

The image processor 20 corresponds to the in-vehicle camera mounting posture detection apparatus. FIG. 3 is a block diagram illustrating a configuration of the image processor 20. As shown in FIG. 3, the image processor 20 includes an input unit 22, a preprocessing unit 24, a parameter calculation unit 26, and an output unit 28.

[1.2.1 Configuration of the Input Unit 22]

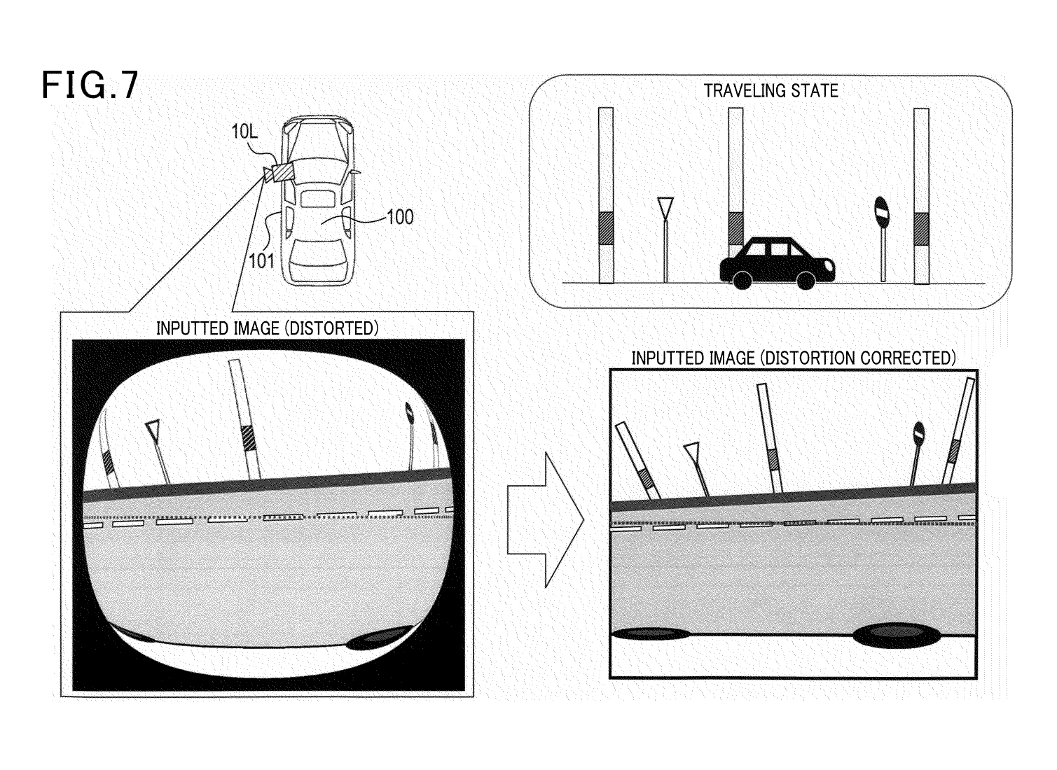

As shown in FIG. 3, the input unit 22 includes an image input section 22A, a distortion correction calculator (distortion correction section) 22B, and a distortion correction information storage 22C. The image input section 22A has a function of receiving picked-up images sequentially outputted from the in-vehicle camera 10. The distortion correction calculator 22B corrects distortion of a picked-up image received by the image input section 22A (see FIG. 7). Herein, the distortion correction calculator 22B corrects distortion of a picked-up image, which is induced by a lens provided to the in-vehicle camera 10. The distortion correction information storage 22C stores information which is used by the distortion correction calculator 22B in correcting distortion of a picked-up image to appropriately provide the information to the distortion correction calculator 22B.

[1.2.2. Configuration of the Preprocessing Unit 24]

As shown in FIG. 3, the preprocessing unit 24 includes a straight line detector 24A, a vanishing point calculator 24B, and a vehicle reference line calculator 24C. The straight line detector 24A detects a vertical line relative to a road surface, from a picked-up image that has been subjected to distortion correction by the input unit 22. The vanishing point calculator 24B calculates a vanishing point of a group of detected vertical lines. The vehicle reference line calculator 24C detects a boundary line between a specific part of the vehicle 100 (left door 101 of the vehicle in the present embodiment) and a road surface from a picked-up image that has been subjected to distortion correction by the input unit 22, and calculates a reference line of the vehicle 100 on the basis of the detected boundary line.

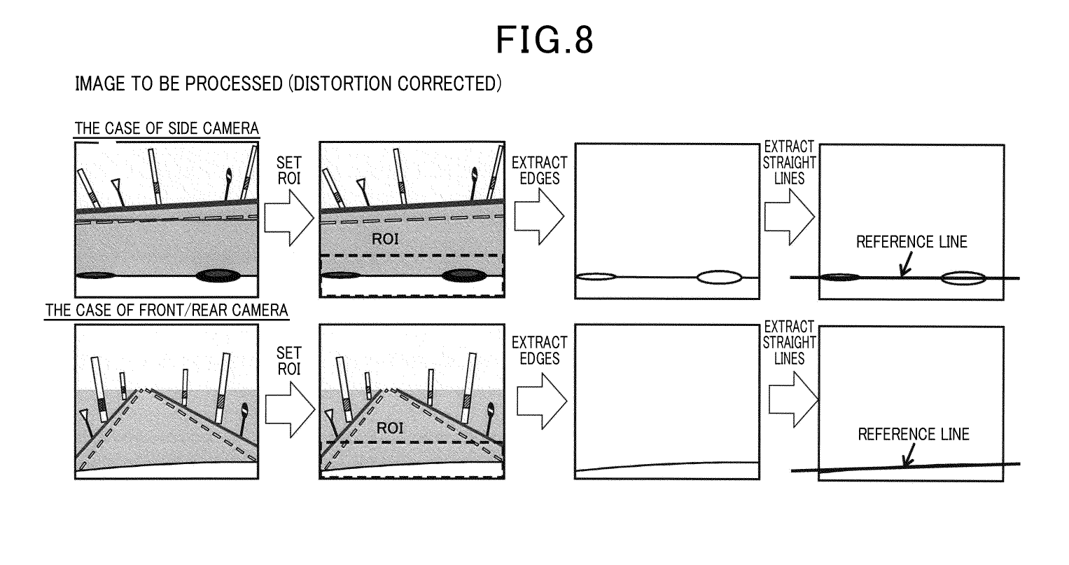

FIG. 8 is diagram illustrating an in-vehicle camera mounting posture detection process. As shown in FIG. 8, firstly, a region of interest (ROI) is narrowed to a vehicle region. For example, the ROI is set to ¼ of the height of an image. It should be noted that the ROI may be narrowed using a method of separating an image into a background portion and a vehicle portion, the image being picked up during movement with a predetermined exposure time or more. After narrowing the ROI, an edge detection process is applied to the ROI and a vehicle reference line is calculated for an image after edge extraction.

For example, noise is removed from an image after edge extraction, followed by detection of straight lines through Hough transform, and then a straight line that has gained a maximum number of votes in a voting space of a Hough transform is extracted as a vehicle reference line. It should be noted that, for example, edge points may be subjected to straight line fitting by means of a least-square method to use the result as a reference line. Alternatively, the Hough transform may be combined with the least-square method to robustly determine a straight line. Specifically, a straight line obtained through the least-square method may be used as an initial straight line. Then, from the initial straight line, edge points having an error (distance to the straight line) of not more than a predetermined threshold may be obtained for use in straight line detection through the Hough transform, and the resultant straight line may be used as a final vehicle reference line.

Herein, the lower end of the left door 101 of the vehicle corresponds to the reference line of the vehicle 100. In the camera 10R set up in the right-side portion of the vehicle 100, the right door of the vehicle corresponds to the specific part and the lower end of the right door corresponds to the reference line of the vehicle 100. In the camera 10F set up in the front portion of the vehicle 100, the bumper portion in the front portion of the vehicle corresponds to the specific part and the upper end of the bumper portion corresponds to the reference line of the vehicle 100. In the camera 10B set up in the rear portion of the vehicle 100, the bumper portion in rear portion of the vehicle corresponds to the specific part and the upper end of the bumper portion corresponds to the reference line of the vehicle 100. It should be noted that, depending on the positions of the front and rear tires (wheels), a part of the lower end of the door 101 may be used as the reference line. Further, depending on the shape of the bumper portion, the center portion of the bumper portion alone may be used as the reference line.

[1.2.3. Configuration of the Parameter Calculation Unit 26]

As shown in FIG. 3, the parameter calculation unit 26 includes a roll angle calculator 26A, a pitch angle calculator 26B, and a yaw angle calculator 26C. The roll angle calculator 26A calculates, as a roll angle of the in-vehicle camera 10, a rotation angle around the Z axis of the camera coordinate system of the in-vehicle camera 10, in the case where the vanishing point of the group of vertical lines calculated by the preprocessing unit 24 overlaps a center line of the image relative to the X direction. The pitch angle calculator 26B calculates, as a pitch angle of the in-vehicle camera 10, a rotation angle around the X axis of the camera coordinate system of the in-vehicle camera 10, in the case where the vanishing point of the group of vertical lines calculated by the preprocessing unit 24 corresponds to infinity. The yaw angle calculator 26C calculates, as a yaw angle of the in-vehicle camera 10, a rotation angle around the Y axis of the camera coordinate system of the in-vehicle camera 10, in the case where the reference line of the vehicle 100 calculated by the preprocessing unit 24 is parallel to the image X axis.

[1.2.4. Configuration of the Output Unit 28]

The output unit 28 includes a parameter storage 28A. The parameter storage 28A stores the roll angle, the pitch angle and the yaw angle of the in-vehicle camera 10 as a mounting posture of the in-vehicle camera 10.

The image processor 20 having a configuration as described above performs an in-vehicle camera mounting posture detection process which will be described below.

[1.3. Configuration of the Display Unit 30]

The display unit 30 shown in FIG. 1 is configured, for example, by a liquid crystal display or an organic EL (electroluminescent) display to display an image processed by the image processor 20 on the basis of a picked-up image derived from the in-vehicle camera 10.

### 2. In-Vehicle Camera Mounting Posture Detection Process

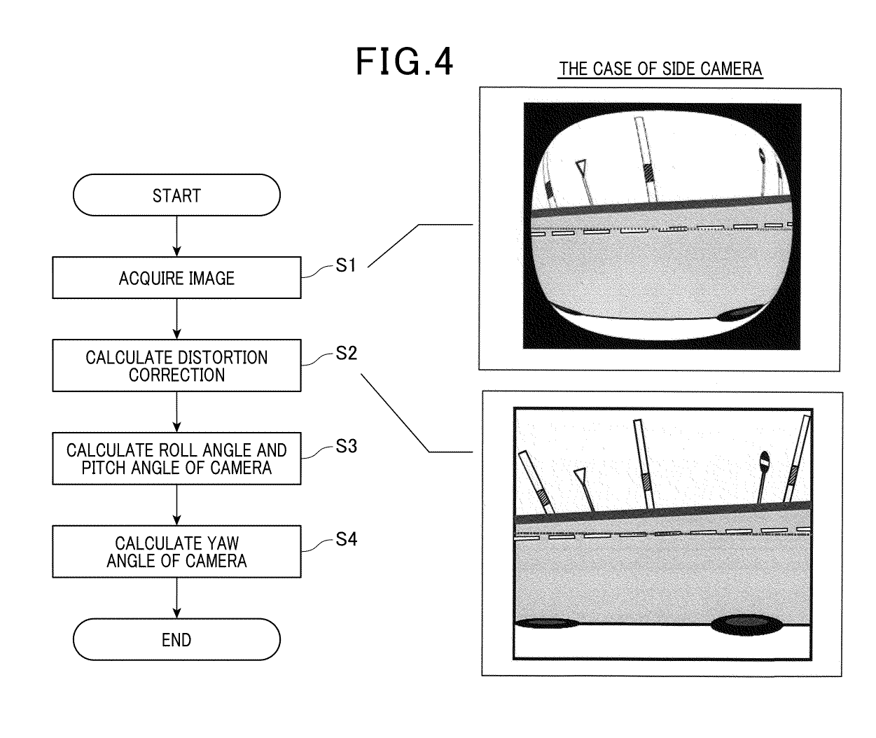

Referring now to FIG. 4, hereinafter is described the in-vehicle camera mounting posture detection process performed by the image processor 20.

[2.1. Main Routine]

FIG. 4 is a flow diagram illustrating, as a main routine, the in-vehicle camera mounting posture detection process. First, in an initial step S1 of the main routine, the image processor 20 acquires an image. Specifically, the image input section 22A of the input unit receives a picked-up image. The picked-up images are sequentially outputted from the in-vehicle camera 10. Then, control proceeds to step S2.

In step S2, distortion correction is calculated. Specifically, the distortion correction calculator 22B of the input unit 22 corrects the distortion of the picked-up image acquired by the image input section 22A. After that, the control proceeds to step S3.

In step S3, the image processor 20 performs a sub-routine described later to calculate a roll angle and a pitch angle of the in-vehicle camera 10. Then, the control proceeds to step S4.

In step S4, the image processor 20 performs a sub-routine described later to calculate a yaw angle of the in-vehicle camera 10. Then, the present process is terminated.

The roll angle, the pitch angle, and the yaw angle of the in-vehicle camera 10 are outputted from the output unit 28 as a mounting posture of the in-vehicle camera 10.

[2.2. Sub-Routine of Step S3]

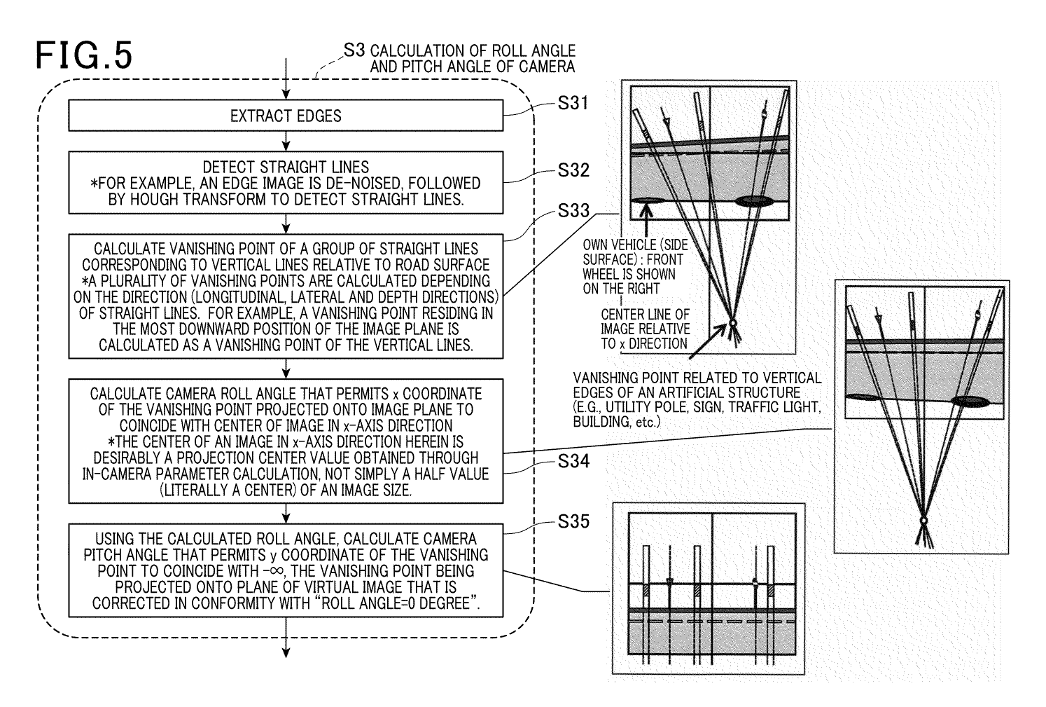

Referring to FIG. 5, the sub-routine of step S3 of the main routine is described. FIG. 5 is a flow diagram of the sub-routine.

First, in initial step S31, edges are extracted from an image. Then, the control proceeds to step S32.

In step S32, straight lines in the image are detected. Then, the control proceeds to step S33.

In step S33, the image processor 20 calculates a vanishing point of a group of straight lines each corresponding to a vertical line relative to a road surface. Then, the control proceeds to step S34.

In step S34, the image processor 20 calculates a roll angle of the in-vehicle camera 10. The roll angle is calculated such that the X coordinate of the vanishing point projected onto the image plane coincides with the center of the image in the X axis direction. Then, the control proceeds to step S35.

In step S35, using the calculated roll angle, the image processor 20 calculates a pitch angle of the in-vehicle camera 10. The pitch angle is calculated such that, in a virtual image corrected in conformity with “roll angle=0 degree”, the Y coordinate of the vanishing point projected onto the plane of the virtual image coincides with “−∞”. Then, the present sub-routine is terminated.

[2.3. Sub-Routine of Step S4]

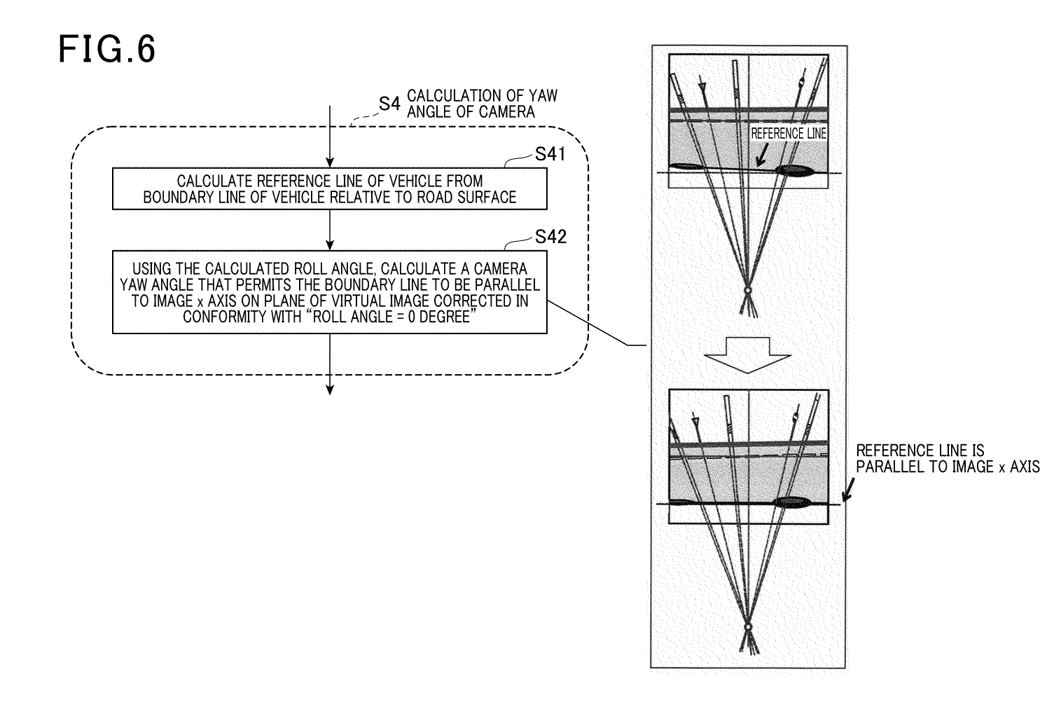

Referring to FIG. 6, the sub-routine of step S4 of the main routine is described. FIG. 6 is a flow diagram of the sub-routine.

First, in initial step S41, the image processor 20 calculates a reference line of the vehicle from a boundary line of the vehicle relative to a road surface. Then, the control proceeds to step S42.

In step S42, using the calculated roll angle, the image processor 20 calculates a yaw angle. The yaw angle is calculated such that, in a virtual image corrected in conformity with “roll angle=0 degree”, the boundary line is parallel to the image X axis on the plane of the virtual image. Then, the present sub-routine is terminated.

### 3. Advantageous Effects of the Embodiment

According to the image processing system 1 of the present embodiment described above, the in-vehicle camera 10 does not have to be set up in such a way that a bilaterally symmetric specific part is included in the imaging range, unlike the conventional art. This increases a degree of freedom and mitigates constraint concerning the position of setting up the in-vehicle camera 10.

Further, according to the image processing system 1 of the present embodiment, calculations are performed strictly taking account of the relationship between the posture of the in-vehicle camera 10 and image projection, unlike the conventional art. Accordingly, highly accurate calibration can be performed.

Hereinafter, aspects of the above-described embodiments will be summarized.

According to a method (S1 to S4) for detecting a mounting posture of an in-vehicle camera (10), the in-vehicle camera (10) is mounted to the vehicle (100) such that a specific part (101) of the vehicle (100) is included in an imaging range, and a picked-up image is received from the in-vehicle camera (10) so as to determine whether or not a mounting posture of the in-vehicle camera (10) is proper.

Specifically, in an image input step (S1), picked-up image is received. In a distortion correction step (S2), distortion of the received picked-up image is corrected. For example, distortion of the picked-up image is corrected which is induced by a lens provided to the in-vehicle camera (10). Next, in a vertical line detection step (S31, S32), a vertical line relative to a road surface is detected from the picked-up image that has been subjected to distortion correction. In a vanishing point calculation step (S33), a vanishing point of a group of the detected vertical lines is calculated.

Furthermore, in a roll angle calculation step (S34), a rotation angle around a Z axis of the in-vehicle camera (10) is calculated as a roll angle of the in-vehicle camera (10), in a case where the calculated vanishing point of the group of vertical lines overlaps a center line of the image relative to an X direction. In addition, in a pitch angle calculation step (S35), a rotation angle around an X axis of the in-vehicle camera (10) is calculated as a pitch angle of the in-vehicle camera (10), in a case where the calculated vanishing point of the group of vertical lines corresponds to infinity.

In addition, in a reference line calculation step (S41), a boundary line between the specific part (101) and the road surface is detected from the picked-up image that has been subjected to the distortion correction, and a reference line of the vehicle (100) is calculated on the basis of the detected boundary line. In a yaw angle calculation step (S42), a rotation angle around a Y axis of the in-vehicle camera (10) is calculated as a yaw angle of the in-vehicle camera (10), in a case where the calculated reference line of the vehicle (100) is parallel to an image X axis

Then, the roll angle of the in-vehicle camera (10), the pitch angle of the in-vehicle camera (10), and the yaw angle of the in-vehicle camera (10) are outputted as a mounting posture of the in-vehicle camera (10).

According to the mounting posture detection method (20) for the in-vehicle camera (10), the in-vehicle camera does not have to be set up in such a way that a bilaterally symmetric specific part is necessarily included in an imaging range, unlike the conventional art. This increases a degree of freedom and mitigates constraint concerning the position of setting up the in-vehicle camera (10). Further, according to the mounting posture detection method (20) for the in-vehicle camera (10), calculations are performed strictly taking account of the relationship between the posture of the in-vehicle camera and image projection, unlike the conventional art. Accordingly, highly accurate calibration can be performed.

The present embodiment can also be realized as a mounting posture detection apparatus (20) for the in-vehicle camera (10), in which the in-vehicle camera (10) is mounted to the vehicle (100) such that the specific part (101) of the vehicle (100) is included in the imaging range, and a picked-up image is received from the in-vehicle camera (10) so as to determine whether or not the mounting posture of the in-vehicle camera (10) is proper.

It will be appreciated that the present invention is not limited to the configurations described above, but any and all modifications, variations or equivalents, which may occur to those who are skilled in the art, should be considered to fall within the scope of the present invention.

What is claimed is:

1. A method for detecting a mounting posture of an in-vehicle camera, in which the in-vehicle camera is mounted to the vehicle such that a specific part of the vehicle is included in an imaging range, and a picked-up image is received from the in-vehicle camera so as to determine whether or not a mounting posture of the in-vehicle camera is proper, the method comprising:
an image input step of receiving the picked-up image;
a distortion correction step correcting distortion of the received picked-up image;
a vertical line detection step of detecting a vertical line relative to a road surface, from the picked-up image that has been subjected to distortion correction;
a vanishing point calculation step of calculating a vanishing point of a group of the detected vertical lines;
a roll angle calculation step of calculating, as a roll angle of the in-vehicle camera, a rotation angle around a Z axis of the in-vehicle camera, in a case where the calculated vanishing point of the group of vertical lines overlaps a center line of the image relative to an X direction;
a pitch angle calculation step of calculating, as a pitch angle of the in-vehicle camera, a rotation angle around an X axis of the in-vehicle camera, in a case where the calculated vanishing point of the group of vertical lines corresponds to infinity;
a reference line calculation step of detecting a boundary line between the specific part and the road surface from the picked-up image that has been subjected to the distortion correction, and calculating a reference line of the vehicle on the basis of the detected boundary line; and
a yaw angle calculation step of calculating, as a yaw angle of the in-vehicle camera, a rotation angle around a Y axis of the in-vehicle camera, in a case where the calculated reference line of the vehicle is parallel to an image X axis, wherein
the roll angle of the in-vehicle camera, the pitch angle of the in-vehicle camera, and the yaw angle of the in-vehicle camera are outputted as a mounting posture of the in-vehicle camera.

2. The method according to claim 1, wherein
in the distortion correction step, distortion of the picked-up image, which is induced by a lens provided to the in-vehicle camera, is corrected.

3. A mounting posture detection apparatus for the in-vehicle camera, in which the in-vehicle camera is mounted to the vehicle such that a specific part of the vehicle is included in an imaging range, and a picked-up image is received from the in-vehicle camera so as to determine whether or not a mounting posture of the in-vehicle camera is proper, the apparatus comprising:
an image input unit which receives the picked-up image;
a distortion correction section which corrects distortion of the picked-up image received by the image input section;
a vertical line detector which detects a vertical line relative to a road surface, from the picked-up image that has been subjected to distortion correction by the distortion correction section;
a reference line calculator which detects a boundary line between the specific part and the road surface from the picked-up image that has been subjected to distortion correction by the distortion correction section, and calculates a reference line of the vehicle 100 on the basis of the detected boundary line;
a vanishing point calculator which calculates a vanishing point of a group of detected vertical lines detected by the vertical line detector;
a roll angle calculator which calculates, as a roll angle of the in-vehicle camera, a rotation angle around a Z axis of the in-vehicle camera, in a case where the vanishing point of the group of vertical lines calculated by the vanishing point calculator overlaps a center line of the image relative to an X direction;
a pitch angle calculator which calculates, as a pitch angle of the in-vehicle camera, a rotation angle around an X axis of the in-vehicle camera, in a case where the vanishing point of the group of vertical lines calculated by the vanishing point calculator corresponds to infinity;
a yaw angle calculator which calculates, as a yaw angle of the in-vehicle camera, a rotation angle around a Y axis of the in-vehicle camera, in a case where the reference line of the vehicle calculated by the reference line calculator is parallel to an image X axis; and
an output unit which outputs the roll angle of the in-vehicle camera calculated by the roll angle calculator, the pitch angle of the in-vehicle camera calculated by the pitch angle calculator, and the yaw angle of the in-vehicle camera calculated by the pitch angle calculator as a mounting posture of the in-vehicle camera.

4. The mounting posture detection apparatus for the in-vehicle camera according to claim 3, wherein
the distortion correction section corrects distortion of the picked-up image induced by a lens provided to the in-vehicle camera.
